(19) United States
(12) Patent Application Publication
(10) Pub. No.: US 2023/0183137 A1
(43) Pub. Date: Jun. 15, 2023

(54) COLORED ZIRCONIA

(71) Applicant: SAINT-GOBAIN CENTRE DE RECHERCHES ET D'ETUDES EUROPEEN, COURBEVOIE (FR)

(72) Inventors: Eric LINTINGRE, AVIGNON (FR); Angélique BOSDEVEIX, PERNES LES FONTAINES (FR)

(21) Appl. No.: 17/916,697

(22) PCT Filed: Apr. 2, 2021
(86) PCT No.: PCT/EP2021/058814

§ 371 Date: Oct. 3, 2022

(30) Foreign Application Priority Data
Apr. 3, 2020 (FR) 2003343

(51) Int. Cl. C04B 35/488; C04B 35/64

(52) U.S. Cl. CPC C04B 35/488; C04B 35/64; C04B 2235/3246; C04B 2235/3218; C04B 2235/3225; C04B 2235/3229; C04B 2235/3241; C04B 2235/3272; C04B 2235/3277; C04B 2235/5436; C04B 2235/5427; C04B 2235/656; C04B 2235/723; C04B 2235/768; C04B 2235/763; C04B 2235/785; C04B 2235/77; C04B 2235/9661; C04B 2235/9669; C04B 2235/5481

(57) ABSTRACT

A particle mixture having: ZrO₂+HfO₂+Y₂O₃+CeO₂; 0%≤Al₂O₃≤1.5%; other oxides than ZrO₂, HfO₂, Y₂O₃, CeO₂ and Al₂O₃: between 0.5% and 12%. The contents of Y₂O₃ and CeO₂, on the basis of the sum of ZrO₂, HfO₂, Y₂O₃ and CeO₂, being such that 1.8%≤Y₂O₃≤3% and 0.1%≤CeO₂≤0.9%. The mixture includes between 0.5% and 10% of particles of an oxide pigment. The content of other oxides and which are not included in the oxide pigment being less than 2%. The particles of the oxide pigment including, for more than 95%, of a material chosen from: oxide(s) of perovskite structure or equivalent of precursor(s) of these oxides, oxides of spinal structure or an equivalent amount of precursor(s) of these oxides, and oxides of hematite structure E₂O₃, oxides of rutile structure FO₂, with “E” and “F” being chosen.

### TECHNICAL FIELD

Zirconia-based sintered products are commonly used notably for the manufacture of decorative articles such as jewelry, watches, bracelets, brooches, tie pins, necklaces, handbags, telephones, furniture, or household utensils, and also for structural parts.

To obtain a color, an oxide pigment may be added to the zirconia. For example, US 2007/270304 describes a zirconia product incorporating an oxide pigment having a spinel structure based on cobalt, zinc, iron and aluminum. JP 2005-289721, EP 0 678 490 and EP 2 448 881 provide further examples of oxide pigments.

Colored zirconia products must have good impact strength and also good resistance to hydrothermal aging, i.e. good resistance to degradation in a humid environment and at a temperature greater than or equal to 50° C., such conditions notably being encountered during the step of machining or polishing of the colored zirconia product. The resistance to hydrothermal aging is an important property because it enables the production of colored zirconia products with high toughness after machining or polishing.

Sintered products of colored yttriated zirconia typically including a molar amount of Y₂O₃ equal to 3% have good resistance to hydrothermal aging but low toughness. Sintered products of colored yttriated zirconia typically including a molar amount of Y₂O₃ equal to 2% have good toughness, but low resistance to hydrothermal aging.

There is thus a need for a sintered colored zirconia product which has a better compromise between toughness and resistance to hydrothermal aging.

One aim of the invention is to at least partially meet this need.

### DESCRIPTION OF THE INVENTION

### SUMMARY OF THE INVENTION

According to the invention, this aim is achieved by means of a particle mixture having the following chemical composition, as mass percentages on the basis of the oxides:

ZrO₂+HfO₂+Y₂O₃+CeO₂: the remainder to 100%;

0%≤Al₂O₂≤1.5%;

oxides other than ZrO₂, HfO₂, Y₂O₃, CeO₂ and Al₂O₃, or “other oxides”: between 0.5% and 12%;

the contents of Y₂O₃ and CeO₂, as molar percentages on the basis of the sum of ZrO₂, HfO₂, Y₂O₃ and CeO₂, being such that 1.8% Y₂O₃≤3% and 0.1% CeO₂≤0.9%, the particle mixture including between 0.5% and 10% of an oxide pigment, as a mass percentage on the basis of the oxides,

the content of oxides which are “other oxides” and which are not included in the oxide pigment being less than 2%, as a mass percentage on the basis of the oxides,

in which particle mixture the particles of the oxide pigment include, preferably consist, for more than 95%, preferably more than 97%, preferably more than 98%, preferably more than 99% of their mass, of a material chosen from:

oxide(s) of perovskite structure, optionally replaced, totally or partially, with an equivalent amount of precursor(s) of these oxides,

oxides of spinel structure, optionally replaced, totally or partially, with an equivalent amount of precursor(s) of these oxides,

oxides of hematite structure E₂O₃, the element E being chosen from the group G_{E}(1) formed by iron, chromium and mixtures of iron and chromium,

oxides of rutile structure FO₂, the element F being chosen from the group G_{F}(1) formed by mixtures of tin and vanadium, mixtures of titanium and chromium and niobium, mixtures of titanium and chromium and tungsten, mixtures of titanium and niobium and manganese, mixtures of tin and chromium, mixtures of chromium and titanium and antimony, mixtures of nickel and antimony and titanium, and mixtures thereof,

and mixtures thereof.

As will be seen in greater detail later in the description, the inventors have discovered that a low CeO₂ content unexpectedly allows the manufacture, with a particle mixture according to the invention, of a sintered colored zirconia product which has an excellent compromise between toughness and resistance to hydrothermal aging, irrespective of the Y₂O₃ content, provided that it remains between 1.8% and 3%.

Among the “other oxides”, a distinction is made between other oxides that are included in the oxide pigment and other oxides that are not included in the oxide pigment.

The other oxides that are not included in the oxide pigment preferably represent less than 1.5%, preferably less than 1%, more preferably less than 0.5%, preferably less than 0.2%, preferably less than 0.1%, as a mass percentage on the basis of the oxides. The other oxides that are not included in the oxide pigment are preferably impurities.

In the particle mixture, ZrO₂ and/or HfO₂ are preferably provided, for more than 90%, more than 95%, preferably 100%, as a mass percentage on the basis of the oxides, in the form of zirconia and/or hafnia, preferably partially or fully stabilized with Y₂O₃ and/or CeO₂. ZrO₂ and/or HfO₂ may also be provided, totally or partially, in the form of a zirconia and/or hafnia precursor, a zirconia or hafnia precursor being a combination of one or more constituents, which, during sintering in a process according to the invention, is converted into zirconia or hafnia, respectively.

In the particle mixture, Y₂O₃ and/or CeO₂ may be provided, for more than 90%, more than 95%, preferably 100%, as a mass percentage on the basis of the oxides, in the form of yttria and/or ceria. Y₂O₃ and/or CeO₂ may also be provided, totally or partially, in the form of an yttria and/or ceria precursor, an yttria and/or ceria precursor being a combination of one or more constituents, which, during sintering in a process according to the invention, is converted into yttria and/or ceria, respectively.

The particle mixture according to the invention may also include one or more of the following optional and preferred features:
the particle mixture consists of oxides for more than 99% of its mass;
the particle mixture does not include a zirconia precursor;
more than 95% of the zirconium, preferably more than 99%, preferably substantially all of the zirconium is present in the form of zirconia ZrO₂;
the particle mixture does not include a hafnia precursor;
more than 95% of the hafnium, preferably more than 99%, preferably substantially all of the hafnium is present in the form of hafnia HfO₂;
the particle mixture does not include a yttria precursor;
more than 95% of the yttrium, preferably more than 99%, preferably substantially all of the yttrium is present in the form of a zirconia at least partially stabilized with Y₂O₃ and/or in the form of yttria Y₂O₃;
the particle mixture does not include a ceria precursor;
more than 95% of the cerium, preferably more than 99%, preferably substantially all of the cerium is present in the form of ceria CeO₂;
the Y₂O₃ content is greater than or equal to 1.9% and less than or equal to 2.5%, as molar percentages on the basis of the sum of ZrO₂, HfO₂, Y₂O₃ and CeO₂;
the CeO₂ content is greater than or equal to 0.3% and less than 0.7%, as molar percentages on the basis of the sum of ZrO₂, HfO₂, Y₂O₃ and CeO₂;
the oxide pigment content is greater than 2% and less than 8%, as mass percentages on the basis of the oxides;
the Al₂O₃ content, as mass percentages on the basis of the oxides, is greater than or equal to 0.2% and less than or equal to 1.2%, or less than 0.1%;
the particle mixture does not include an alumina precursor;
more than 95%, preferably more than 99% of the aluminum, preferably substantially all of the aluminum is present in the form of alumina Al₂O₃;
the oxide pigment does not include the element aluminum and/or does not include the element cerium and/or does not include the element yttrium and/or does not include the element zirconium;
the oxide pigment consists for more than 95%, preferably for more than 97%, preferably for more than 98%, preferably for more than 99% of its mass of an oxide of spinel structure chosen from an iron-chromium spinel, an iron-cobalt spinel, an iron-chromium-cobalt spinel, a cobalt-magnesium-zinc-chromium spinel, a cobalt-nickel-iron-chromium spinel, a nickel-manganese iron-chromium spinel, a zinc-manganese-chromium-iron spinel, a manganese-iron spinel, a chromium-iron-nickel spinel, a cobalt-chromium spinel, a copper-chromium spinel, a cobalt-titanium spinel, an iron-titanium spinel, a zinc-iron spinel, a zinc-iron-chromium spinel, a cobalt-tin spinel, a nickel-iron spinel, an iron-manganese-chromium spinel, a zinc-manganese-chromium spinel, and mixtures thereof;
the oxide pigment consists for more than 95%, preferably for more than 97%, preferably for more than 98%, preferably for more than 99% of its mass of a spinel chosen from an iron-chromium spinel having a mass ratio of iron expressed as Fe₂O₃ to chromium expressed as Cr₂O₃, Fe₂O₃/Cr₂O₃ of greater than 0 and less than 3, an iron-cobalt spinel having a mass ratio of iron expressed as Fe₂O₃ to cobalt expressed as Co₃O₄, Fe₂O₃/Co₃O₄ of greater than 0.5 and less than 4, an iron-chromium-cobalt spinel having a mass ratio of iron expressed as Fe₂O₃ to chromium expressed as Cr₂O₃, Fe₂O₃/Cr₂O₃ of greater than 0.5 and less than 3, and a mass ratio of iron expressed as Fe₂O₃ to cobalt expressed as Co₃O₄, Fe₂O₃/Co₃O₄ of greater than 0.5 and less than 3, and mixtures thereof;
the particle mixture has a median size (D₅₀) of less than 2 μm and/or a ratio (D₉₀-D₁₀)/D₅₀ of less than 2.

The invention also relates to an intermediate product consisting of particles bound by means of an organic binder, said particles forming together, after debinding of the intermediate product, a particle mixture according to the invention.

Needless to say, the debinding must be performed under conditions which do not substantially modify the features (composition, dimensions, specific surface area, etc.) of the particles of the particle mixture. In particular, the debinding may be performed at a sufficiently low temperature to not modify said particles. The debinding may also be, for example, solvent debinding.

The invention also relates to a process for manufacturing a sintered colored zirconia product, said process including the following steps:

a) preparing a starting feedstock including a particle mixture according to the invention, optionally in the form of an intermediate product according to the invention, and optionally one or more organic constituents;

b) forming said starting feedstock so as to obtain a preform;

c) sintering said preform at a temperature greater than or equal to 1300° C., so as to obtain a sintered colored zirconia product.

The invention also relates to a sintered colored zirconia product having a chemical analysis such that, as mass percentages on the basis of the oxides:

ZrO₂+HfO₂+Y₂O₃+CeO₂: the remainder to 100%;

0%≤Al₂O₃≤1.5%;

oxides other than ZrO₂, HfO₂, Y₂O₃, CeO₂ and Al₂O₃, or “other oxides”: between 0.5% and 12%;

the contents of Y₂O₃ and CeO₂, as molar percentages on the basis of the sum of ZrO₂, HfO₂, Y₂O₃ and CeO₂, being such that 1.8%≤Y₂O₃≤3% and 0.1% CeO₂≤0.9%, between 0.5% and 10% of the oxide phases being in an oxide pigment, as mass percentages on the basis of the oxides,

the content of oxides which are “other oxides” and which are not included in the oxide pigment, preferably impurities, being less than 2%, as a mass percentage on the basis of the oxides,

in which sintered product the oxide pigment includes, preferably consists for more than 95%, preferably for more than 97%, preferably for more than 98%, preferably for more than 99% of its mass of a material chosen from:
oxide(s) of perovskite structure,
oxides of spinel structure,
oxides of hematite structure E₂O₃, the element E being chosen from the group G_{E}(1) formed by iron, chromium and a mixture of iron and chromium,
oxides of rutile structure FO₂, the element F being chosen from the group G_{F}(1) formed by mixtures of tin and vanadium, mixtures of titanium and chromium and niobium, mixtures of titanium and chromium and tungsten, mixtures of titanium and niobium and manganese, mixtures of tin and chromium, mixtures of chromium and titanium and antimony, mixtures of nickel and antimony and titanium, and mixtures thereof,
and mixtures thereof.

A sintered colored zirconia product according to the invention may also include one or more of the following optional and preferred features:
the Y₂O₃ content is greater than or equal to 1.9% and less than or equal to 2.5%, as molar percentages on the basis of the sum of ZrO₂, HfO₂, Y₂O₃ and CeO₂;
the CeO₂ content is greater than or equal to 0.3% and less than 0.7%, as molar percentages on the basis of the sum of ZrO₂, HfO₂, Y₂O₃ and CeO₂;
the oxide pigment content is greater than 2% and less than 8%, as molar percentages on the basis of the oxides;
the monoclinic zirconia fraction is less than 10%;
more than 95%, preferably more than 99%, preferably substantially 100%, as a mass percentage, of the cerium and/or yttrium and/or zirconium and/or aluminum is outside the oxide pigment;
more than 95%, preferably more than 99%, preferably substantially 100%, as a mass percentage, of the cerium and yttrium and zirconium is outside the pigment, in the form of an at least partially stabilized zirconia;
more than 95%, preferably more than 99%, preferably substantially 100%, as a mass percentage, of the aluminum is outside the pigment, in the form of alumina;
the sintered colored zirconia product consists for more than 99% of its mass of oxides, and/or has an average grain size of less than 2 μm, and/or has a grain size distribution with a standard deviation of less than 0.15 μm;
the sintered colored zirconia product:
has a chemical composition such that, as a mass percentage on the basis of the oxides:
   0%≤Al₂O₃≤1.2%;
   oxides which are “other oxides” and which are not included in the oxide pigment, preferably impurities: <1%,
the contents of Y₂O₃ and CeO₂, as molar percentages on the basis of the sum of ZrO₂, HfO₂, Y₂O₃ and CeO₂, being such that the Y₂O₃ content is greater than or equal to 1.9% and less than or equal to 2.5%, and the CeO₂ content is greater than or equal to 0.3% and less than 0.7%, and
contains 3% to 7% of an oxide pigment consisting of more than 95%, preferably more than 97%, preferably more than 98%, preferably more than 99% of its mass of an oxide of spinel structure chosen from an iron-chromium spinel having a mass ratio of iron expressed as Fe₂O₃ to chromium expressed as Cr₂O₃, Fe₂O₃/Cr₂O₃ of greater than 0 and less than 3, an iron-cobalt spinel having a mass ratio of iron expressed as Fe₂O₃ to cobalt expressed as Co₃O₄, Fe₂O₃/Co₃O₄ of greater than 0.5 and less than 4, an iron-chromium-cobalt spinel having a mass ratio of iron expressed as Fe₂O₃ to chromium expressed as Cr₂O₃, Fe₂O₃/Cr₂O₃ of greater than 0.5 and less than 3, and a mass ratio of iron expressed as Fe₂O₃ to cobalt expressed as Co₃O₄, Fe₂O₃/Co₃O₄ of greater than 0.5 and less than 3, and mixtures thereof;
has an average grain size of less than 1.5 μm, and a grain size distribution with a standard deviation of less than 0.15 μm;
the sintered colored zirconia product is obtained or may have been obtained by means of a manufacturing process according to the invention.

The invention also relates to a sintered colored zirconia product obtained or capable of being obtained by means of a manufacturing process according to the invention.

The invention also relates to a device chosen from the group consisting of an item of jewelry, a watch, a bracelet, a necklace, a ring, a brooch, a tie pin, a handbag, a telephone, an item of furniture, a household utensil, a handle, a switch, a button, a plating, a visible part of a consumer goods equipment, a spectacle frame part, a tableware item, a welding pin and a frame, said device including a sintered product according to the invention or manufactured according to a process according to the invention.

Definitions
Conventionally, the term “sintering” refers to the consolidation of a granular agglomerate (“preform”) by heat treatment at at least 1100° C., possibly with partial or total melting of some (but not all) of its constituents.
The “grains” of a sintered product consist of the particles of the particle mixture agglomerated by sintering.
The particle sizes corresponding to the percentages equal to 10%, 50% and 90%, respectively, by mass, on the cumulative particle size distribution curve of the powder or of the particle mixture are called “percentiles” 10 (noted D₁₀), 50 (noted D₅₀) and 90 (noted D90) of a powder or of a particle mixture, respectively, said particle sizes being classified in ascending order. According to this definition, 10% by mass of the particles of the powder or the particle mixture have a size less than Dlo and 90% of the particles, by mass, have a size greater than or equal to D₁₀. The percentiles may be determined, for example, with a laser granulometer.
The “median size” of a particle powder or a particle mixture is called the 50 percentile, D₅₀. The median size thus divides the particles of the powder or of the particle mixture into first and second populations equal in mass, these first and second populations including only particles having a size greater than or equal to, or less than, respectively, the median size.
The “average size” of the grains of a sintered product is the dimension measured according to a “Mean Linear Intercept” method. A measurement method of this type is described in the standard ASTM E1382.
A perovskite crystallographic structure conventionally corresponds to a particular arrangement of elements in sites conventionally called “A sites” and “B sites”. The elements arranged in the A and B sites are usually referred to as “A elements” and “B elements”, respectively.
   Among the compounds of perovskite crystallographic structure, a distinction is made between “oxides of perovskite structure”. These oxides notably comprise compounds of the formula ABO₃. Not all A and/or B sites are always occupied by A and/or B elements, respectively.
   For example, a lanthanum-manganese (LM) oxide of perovskite structure is a compound in which the A element is lanthanum and the B element is manganese. Its structure is conventionally defined by a formula of the type LaMnO₃. Another example may be a lanthanum-cobalt-iron-manganese oxide of perovskite structure in which the element A is lanthanum and the element B is a mixture of cobalt, iron and manganese defined by a formula of the type LaCoₓFe_{y}Mn_{z}O₃, with x+y+z=1, x, y and z being the mole fractions of the elements cobalt, iron and manganese, respectively.
A spinel crystallographic structure conventionally corresponds to a particular arrangement of C and D elements in sites conventionally called “octahedral sites” and “tetrahedral sites”.
   Compounds of spinel crystallographic structure notably comprise compounds of the formula CD204, referred to as “direct spinels”, in which the C element occupies a tetrahedral site and the D element occupies an octahedral site, and compounds of the formula D(C,D)O₄, referred to as “reverse spinels”, in which the D element occupies tetrahedral and octahedral sites and the C element occupies an octahedral site.
   For example, a cobalt-chromium oxide of direct spinel structure is a compound in which the C element is cobalt, arranged at C sites, and the D element is chromium, arranged at D sites. Its structure is conventionally defined by a formula of the type CoCr₂O₄. Another example of spinel is the reverse spinel TiFe₂O₄, in which the C element is titanium arranged at D sites, and the D element is iron arranged at C and D sites.
A hematite crystallographic structure conventionally corresponds to a particular arrangement of elements in sites conventionally called “E sites”. The elements arranged at the E sites are usually referred to as “E elements”.
   Among the compounds of hematite crystallographic structure, the “oxides of hematite structure” are particularly distinguished. These oxides notably comprise compounds of the formula E₂O₃.
   For example, an iron-chromium oxide of hematite structure is a compound in which the E element is a mixture of iron and chromium. Its structure is conventionally defined by a formula of the type (FeₓCr_{y})₂O₃ with x+y=1, x and y being the mole fractions of the elements iron and chromium, respectively.
A rutile crystallographic structure conventionally corresponds to a particular arrangement of elements in sites conventionally called “F sites”. Elements arranged at F sites are usually referred to as “F elements”.
   Among the compounds of rutile crystallographic structure, “oxides of rutile structure” are particularly distinguished. These oxides notably comprise compounds of the formula FO₂.
   For example, a manganese-niobium-titanium oxide of rutile structure is a compound in which the F element is a mixture of manganese and niobium and titanium. Its structure is conventionally defined by a formula of the type (MnₓNb_{y}Ti_{z})O₂, with x+y+z=1, x, y and z being the mole fractions of the elements manganese, niobium and titanium, respectively.
An A, B, C, D, E, or F element may include several constituents. A mole fraction of one of these constituents refers to the mole fraction of that constituent in said element.
The concept of “pigment” is well known to those skilled in the art. A pigment is a powder which, when incorporated into a preform, leads to a coloration during sintering in a process according to the invention.
   An “oxide pigment” is a pigment consisting of oxides.
   An “oxide pigment” may consist of a mixture of powders of different nature, each of which constitutes an oxide pigment, for example including a first oxide pigment of an oxide of perovskite structure and a second oxide pigment of an oxide of spinel structure, or including a first oxide pigment of a first oxide of spinel structure and a second oxide pigment of a second oxide of spinel structure, which is different from the first oxide of spinel structure.
   An oxide pigment is conventionally in the form of a powder with a median particle size of less than 50 μm.
   In a particle mixture according to the invention, the oxide pigment preferably has a median size (D₅₀) of less than 5 μm, preferably less than 3 μm, preferably less than 2 μm, preferably less than 1 μm.
By extension, the term “oxide pigment” also refers to the grains in the sintered product corresponding to the oxide pigment introduced in the starting feedstock.
The “content” of perovskite, spinel, hematite or rutile, excluding impurities, as a percentage, is defined according to formula (1) below:

T=100*(A_{PIG})/(A_{PIG}+A_{secondary phase}) (1)
in which
   A_{PIG} is the area measured on an X-ray diffraction pattern obtained using a Brüker D8 Endeavor machine with a copper XD tube, without deconvolution treatment, of the main diffraction peak or multiplet of the structure considered (perovskite, spinel, hematite or rutile, respectively);
   A_{secondary phase} is the area measured on the same pattern, without deconvolution treatment, of the main diffraction peak or multiplet of the secondary phase. The secondary phase is the phase whose main peak or multiplet has the largest area, without taking into account said structure.
A multiplet is the partial superposition of several peaks. For example, a multiplet consisting of two peaks is a doublet, a multiplet consisting of three peaks is a triplet.
The “other oxides” that are not included in the oxide pigment are preferably “impurities”, i.e. unavoidable oxides, necessarily introduced with the raw materials. In particular, oxides of sodium and other alkali metals are impurities. Examples that may be mentioned include Na₂O or K₂O. However, hafnium oxide is not considered an impurity.

It is considered that a total impurity content of less than 2% does not substantially alter the results obtained.
In the context of the present patent application, HfO₂ is considered not chemically dissociable from ZrO₂. In the chemical composition of a product including zirconia, “ZrO₂” or “ZrO₂+HfO₂” thus refers to the total content of these two oxides. According to the present invention, HfO₂ is not intentionally added to the starting feedstock. HfO₂ thus refers only to trace amounts of hafnium oxide, this oxide always being naturally present in zirconia sources at levels generally below 2%.
Unless otherwise mentioned, all the oxide contents, particularly in a particle mixture or sintered product according to the invention, are mass percentages on the basis of the oxides. A mass content of an oxide of a metal element refers to the total content of that element expressed as the most stable oxide, according to the usual industry convention. For example, ZrO₂, HfO₂, Y₂O₃, CeO₂ and Al₂O₃ refer to the contents of the elements zirconium, hafnium, yttrium, cerium and aluminum after conversion to the form ZrO₂, HfO₂, Y₂O₃, CeO₂ and Al₂O₃, respectively.
   The form of an oxide of a metal element is, however, not limited. For example, cerium may take the form of ceria CeO₂, but also the form of Ce₂O₃, or the form of an oxide of an oxide pigment. Irrespective of its form, cerium is thus conventionally converted into the CeO₂ form to determine its mass content.
The term “precursor” of an oxide means one or more constituents that are capable of providing said oxide during a sintering step of a manufacturing process according to the invention. For example, aluminum hydroxides are precursors of alumina. In the particular case of an oxide of perovskite structure, a precursor of said oxide of perovskite structure is a compound consisting of an intimate mixture of the oxides and/or precursors of the oxides composing said oxide of perovskite structure. Such an intimate mixture may be obtained, for example, by coprecipitation or atomization. Preferably, the intimate mixture is consolidated by heat treatment. For example, considering the case of a lanthanum-cobalt-iron-manganese oxide of perovskite structure of formula LaCoₓFe_{y}Mn_{z}O₃, with x+y+z=1, x, y and z being the mole fractions of the elements cobalt, iron and manganese, respectively, a precursor of this oxide of perovskite structure is an intimate mixture of lanthanum oxide, cobalt oxide, iron oxide and manganese oxide. Another possible precursor is an intimate mixture of precursors of these oxides, for instance an intimate mixture of lanthanum nitrate, cobalt nitrate, iron nitrate and manganese nitrate.
An amount of a precursor of an oxide is said to be “equivalent” to an amount of said oxide when, on sintering, it leads to said amount of said oxide.
The term “temporary” means “at least partially removed from the preform during sintering” during the implementation of a process according to the invention.
The specific surface area is calculated via the BET (Brunauer Emmett Teller) method as described in the Journal of the American Chemical Society, 60 (1938), pages 309 to 316.
The ratio F_{ZrO2m} between monoclinic zirconia and all the zirconia, expressed as a percentage, is called the “monoclinic zirconia fraction”. This ratio may be determined by X-ray diffraction on the surface of the sample to be characterized (not ground in the form of a powder) using a D8 Endeavor machine from the company Brüker. The diffraction pattern is acquired using this apparatus, over an angular range 20 between 5° and 100°, with a step size of 0.01°, and a counting time of 0.34 s/step. The front optics have a 0.3° primary slit and a 2.5° Soller slit. The sample is rotating on itself at a speed equal to 15 rpm, with the use of an automatic knife. The rear optics include a 2.5° Soller slit, a 0.0125 mm nickel filter and a 1D detector with an aperture equal to 4°.
   The diffraction patterns are then qualitatively analyzed using the EVA software and the ICDD2016 database.
   Once the phases present have been highlighted, the diffraction patterns are analyzed, with the HighScore Plus software from the company Malvern Panalytical, according to the following strategy: “pseudo-Voigt split width” function is used, the peaks of the (−111) and (111) planes of the monoclinic phase and the peak of the (111) plane of the stabilized phase are chosen using the “Insert Peak” function, the height of each of said peaks being determined by automatic refinement using the “Default profile fit” function, and taken to be equal to the “Height (cts)” value.
   Given the following:
   H_{M(-111)}: the height of the (−111) plane peak of the monoclinic zirconia phase, located at about 2θ=28.2°,
   H_{M(111)}: the height of the (111) plane peak of the monoclinic zirconia phase, located at about 2θ=31.3°,
   H_{S(111)}: the peak height of the (111) plane of the stabilized zirconia phase (in the quadratic and/or cubic form), localized at about 2θ=30.2°.
   The monoclinic zirconia fraction, F_{ZrO2m}, is determined using the following formula:

[H_{M(-111})+H_{M(111)}]/[H_{M(-111)}+H_{M(111)}+H_{S(111)}].
The term “at least partially stabilized zirconia” means a partially stabilized zirconia or a fully stabilized zirconia. A partially stabilized zirconia is a zirconia including monoclinic zirconia, and having a monoclinic zirconia fraction of less than 50%, the other phases present being the quadratic phase and/or the cubic phase.
   CeO₂ and Y₂O₃ are used to stabilize the zirconia but may also be present outside it.
The term “absolute density” of a sintered zirconia product means the absolute density AD calculated using equation (1) below:

AD=100/[(x/3.987)+(100−x)/ADz] (1)
where x is the alumina content, as a mass percentage, and
ADz is the absolute density of the zirconia stabilized with Y₂O₃ and CeO₂, calculated by dividing the mass of the elementary unit cell of the zirconia by the volume of said elementary unit cell, the zirconia being considered stabilized only in the quadratic phase.
The volume of the elementary unit cell is calculated using the parameters of said unit cell determined by X-ray diffraction. The mass of the elementary unit cell is equal to the sum of the mass of the elements Zr, O, Y and Ce, present in said unit cell, considering that all of the Y₂O₃ and CeO₂ stabilizes the zirconia.
The term “apparent density” of a sintered product, conventionally means the ratio equal to the mass of said sintered product divided by the volume occupied by said sintered product. It may be measured by imbibition, according to the principle of Archimedes' thrust.
The term “relative density” of a sintered product means the ratio equal to the apparent density divided by the absolute density, expressed as a percentage.
The color parameters L*, a* and b* are measured according to the standard NF ISO 7724. When the color black is required, said color corresponds to the following L*, a*, and b* characteristics:
   L*<5, preferably L*<4, preferably L*<3, preferably L*<2, preferably L* <1, and
         |a*|<8, preferably |a*|<6, preferably |a*|<5, preferably |a*|<4, preferably |a*|<3, preferably |a*|<2, preferably |a*|<1, and
         |b*|<8, preferably |b*|<6, preferably |b*|<5, preferably |b*|<4, preferably |b*|<3, preferably |b*|<2, preferably |b*|<1.
Unless otherwise mentioned, all the means are arithmetic means.
Unless otherwise mentioned, all the percentages are mass percentages on the basis of the oxides.
The terms “include”, “comprise” or “have” shall be interpreted in a nonlimiting manner.

### DETAILED DESCRIPTION

### Particle Mixture According to the Invention

The particle mixture according to the invention is noteworthy as regards its composition.

Composition

A particle mixture according to the invention preferably consists of oxides for more than 98%, preferably for more than 99%, preferably for more than 99.5%, preferably for more than 99.9%, of its mass. Preferably, the particle mixture according to the invention consists substantially entirely of oxides.

Preferably, more than 90%, preferably more than 95%, preferably 100% of the zirconium is non-pigment zirconium, as a mass percentage.

Preferably, more than 90%, preferably more than 95%, preferably 100% of the zirconium is in the form of zirconia, as a mass percentage.

Y₂O₃ and CeO₂ are known stabilizers of zirconia. In the particle mixture according to the invention, they may or may not stabilize the zirconia. According to the invention, however, the particle mixture must lead to a sintered product in which the zirconia is at least partially stabilized, preferably fully stabilized with these oxides.

In the particle mixture, the zirconia is preferably at least partially stabilized with Y₂O₃. Preferably then, a ceria CeO₂ powder is used as the CeO₂ source.

In one embodiment,

more than 90%, preferably more than 95%, preferably 100% of the cerium is in the form of ceria and/or a precursor of ceria, preferably in the form of ceria, as a mass percentage, and

more than 90%, preferably more than 95%, preferably 100% of the yttrium is in the form of yttria and/or an yttria precursor, as a mass percentage.

The ceria and/or ceria precursor and/or the yttria and/or yttria precursor may, partially or totally, be incorporated into the particle mixture in the form of a powder, i.e. in a form separate from the zirconia, such that, after sintering, the zirconia is at least partially stabilized. In this embodiment, the median size of the powder of yttria and/or the yttria and ceria precursor and/or of the ceria precursor is preferably less than 1 μm, preferably less than 0.5 μm, more preferably less than 0.3 μm. The stabilization efficiency of the zirconia during sintering is thereby advantageously improved.

In one embodiment, the particle mixture includes particles in which stabilized or non-stabilized zirconia and yttria and/or ceria are intimately mixed. Such an intimate mixture may be obtained, for example, by co-precipitation, thermal hydrolysis or atomization, and possibly consolidated by heat treatment. In a said mixture, the yttria and/or ceria may be replaced with an equivalent amount of precursor(s).

Preferably, the particle mixture does not include any yttria precursor.

Preferably, the particle mixture does not include any ceria precursor.

Preferably, the particle mixture does not include any zirconia precursor, or any hafnia precursor.

Preferably, substantially all of the cerium is present in the form of ceria CeO₂. Thus, the particle mixture has substantially no cerium in the form of Ce₂O₃. Advantageously, the development of the desired colors is thereby improved.

Preferably, the monoclinic zirconia fraction in the particle mixture is less than 50%, preferably less than 40%, preferably less than 30%, preferably less than 20%.

Preferably, the Y₂O₃ content is greater than or equal to 1.9%, preferably greater than or equal to 2% and/or preferably less than or equal to 2.5%, preferably less than or equal to 2.4%, preferably less than or equal to 2.2%, as molar percentages on the basis of the sum of ZrO₂, HfO₂, Y₂O₃ and CeO₂.

Preferably, the Y₂O₃ content outside the oxide pigment is greater than or equal to 1.9%, preferably greater than or equal to 2% and/or preferably less than or equal to 2.5%, preferably less than or equal to 2.4%, preferably less than or equal to 2.2%, as molar percentages on the basis of the sum of ZrO₂, HfO₂, Y₂O₃ and CeO₂.

Preferably, the CeO₂ content is greater than or equal to 0.2%, preferably greater than or equal to 0.3%, preferably greater than or equal to 0.4% and/or preferably less than 0.8%, preferably less than 0.7%, preferably less than 0.6%, as molar percentages on the basis of the sum of ZrO₂, HfO₂, Y₂O₃ and CeO₂.

Preferably, the CeO₂ content outside the oxide pigment is greater than or equal to 0.2%, preferably greater than or equal to 0.3%, preferably greater than or equal to 0.4% and/or preferably less than 0.8%, preferably less than 0.7%, preferably less than 0.6%, as molar percentages on the basis of the sum of ZrO₂, HfO₂, Y₂O₃ and CeO₂.

Preferably, the Y₂O₃ content is greater than or equal to 1.9%, preferably greater than or equal to 2% and/or preferably less than or equal to 2.5%, preferably less than or equal to 2.4%, preferably less than or equal to 2.2%, and the CeO₂ content is greater than or equal to 0.2%, preferably greater than or equal to 0.3%, preferably greater than or equal to 0.4% and less than 0.8%, preferably less than 0.7%, preferably less than 0.6%, as molar percentages on the basis of the sum of ZrO₂, HfO₂, Y₂O₃ and CeO₂. Advantageously, the sintered product obtained from the particle mixture has an excellent compromise between toughness and resistance to hydrothermal aging.

Preferably, the Y₂O₃ content outside the oxide pigment is greater than or equal to 1.9%, preferably greater than or equal to 2% and/or preferably less than or equal to 2.5%, preferably less than or equal to 2.4%, preferably less than or equal to 2.2%, and the CeO₂ content outside the oxide pigment is greater than or equal to 0.2%, preferably greater than or equal to 0.3%, preferably greater than or equal to 0.4% and less than 0.8%, preferably less than 0.7%, preferably less than 0.6%, as molar percentages on the basis of the sum of ZrO₂, HfO₂, Y₂O₃ and CeO₂.

Preferably, the particle mixture according to the invention has an average size of stabilized zirconia crystallites of greater than 10 nm, preferably greater than 20 nm and less than 60 nm. The average crystallite size is conventionally determined by X-ray diffraction according to the method described later in the present description.

In a preferred embodiment, the Al₂O₃ content is greater than or equal to 0.2%, preferably greater than or equal to 0.25% and preferably less than or equal to 1.2%, preferably less than or equal to 1%, preferably less than or equal to 0.8%, as mass percentages on the basis of the oxides. Advantageously, the sinterability of the particle mixture is thereby improved.

In a preferred embodiment, the Al₂O₃ content outside the oxide pigment is greater than or equal to 0.2%, preferably greater than or equal to 0.25% and preferably less than or equal to 1.2%, preferably less than or equal to 1%, preferably less than or equal to 0.8%, as mass percentages on the basis of the oxides.

However, tests have shown that the presence of Al₂O₃ is not essential. In one embodiment, the Al₂O₃ content may in particular be less than 0.1%, less than 0.005%, less than 0.003%, less than 0.002%, or substantially zero, as mass percentages on the basis of the oxides. Preferably, more than 90%, more than 95%, preferably 100% of the Al₂O₃ is in the form of alumina, as a mass percentage on the basis of Al₂O₃.

The alumina may be replaced, partially or totally, with an alumina precursor. Preferably, Al₂O₃ is substantially present in the form of corundum.

According to the invention, the particle mixture also includes an oxide pigment.

The particles of said oxide pigment include, preferably consist for more than 95%, preferably for more than 97%, preferably for more than 98%, preferably for more than 99% of their mass, of a material chosen from:
oxide(s) of perovskite structure, optionally replaced, totally or partially, with an equivalent amount of precursor(s) of these oxides,
oxides of spinel structure, optionally replaced, totally or partially, with an equivalent amount of precursor(s) of these oxides,
oxides of hematite structure E₂O₃, the E element being chosen from the group G_{E}(1) formed by iron, chromium and a mixture of iron and chromium,
oxides of rutile structure FO₂, the element F being chosen from the group G_{F}(1) formed by mixtures of tin and vanadium, mixtures of titanium and chromium and niobium, mixtures of titanium and chromium and tungsten, mixtures of titanium and niobium and manganese, mixtures of tin and chromium, mixtures of chromium and titanium and antimony, mixtures of nickel and antimony and titanium, and mixtures thereof,
and mixtures thereof.

The particles of said oxide pigment of a particle mixture according to the invention may be obtained by various processes, such as melting, solid phase synthesis, pyrolysis of salts, precipitation of hydroxides and calcination thereof, or sol-gel synthesis.

Preferably, the constituents of said oxide of perovskite, spinel, hematite or rutile structure represent more than 95%, preferably more than 97%, preferably more than 98%, preferably more than 99%, or even substantially 100% by mass of said material. Preferably, the remainder to 100% of the constituents of said oxide of perovskite, spinel, hematite or rutile structure consists of impurities.

The inventors have found that if the particle mixture includes more than 10% by mass of said oxide pigment, the mechanical properties, notably the toughness and bending stress, of the sintered products are degraded.

A minimum content of 0.5% of said oxide pigment in the particle mixture is considered essential to obtain a sintered product having a good appearance with well developed and homogeneous colors.

The oxide pigment used preferably has a median size of less than 5 μm, preferably less than 3 μm, preferably less than 2 μm, preferably less than 1 μm. Advantageously, the efficiency of said oxide pigment in the sintered product is thereby improved.

Preferably, the content of oxide pigment is greater than 2%, preferably greater than 3% and/or less than 9%, preferably less than 8%, preferably less than 7%, as a mass percentage on the basis of the oxides in the particle mixture.

Preferably, the particle mixture does not contain any oxide pigment containing the element zirconium.

Preferably, the particle mixture does not contain any oxide pigment containing the element cerium.

Preferably, the particle mixture does not contain any oxide pigment containing the element yttrium.

Preferably, the particle mixture does not contain any oxide pigment containing the element aluminum.

In a first embodiment, the oxide pigment consists for more than 95%, preferably more than 97%, preferably more than 98%, preferably more than 99% of its mass of an oxide of the ABO₃ perovskite structure, and the particle mixture according to the invention may also include one or more of the following optional features:
the element A at the A site of the perovskite structure is chosen from the group G_{A}(1) formed by calcium Ca, strontium Sr, barium Ba, lanthanum La, praseodymium Pr, neodymium Nd, bismuth Bi, and mixtures thereof;
preferably, the element A is chosen from the group G_{A}(2) formed by lanthanum, praseodymium, neodymium, bismuth and mixtures thereof;
preferably, the element A is chosen from the group G_{A}(3) formed by lanthanum;
the element B at the B site of the perovskite structure is chosen from the group G_{B}(1) formed by mixtures of cobalt and iron, mixtures of cobalt and manganese, mixtures of cobalt and chromium, mixtures of cobalt and nickel, mixtures of chromium and manganese, mixtures of chromium and nickel, mixtures of chromium and iron, mixtures of manganese and iron, mixtures of manganese and nickel, mixtures of nickel and iron, mixtures of cobalt and titanium, mixtures of cobalt and copper, cobalt, mixtures of chromium and titanium, mixtures of chromium and copper, mixtures of nickel and titanium, chromium, nickel, copper, iron, mixtures of nickel and copper, and mixtures thereof;
preferably, the element B is chosen from the group G_{B}(2) formed by mixtures of cobalt and iron, mixtures of cobalt and manganese, mixtures of chromium and manganese, mixtures of chromium and iron, mixtures of cobalt and chromium and iron, mixtures of cobalt and chromium and iron and manganese, mixtures of cobalt and iron and manganese, mixtures of cobalt and chromium, mixtures of cobalt and nickel, mixtures of cobalt and titanium, mixtures of cobalt and copper, cobalt, mixtures of chromium and nickel, mixtures of chromium and titanium, mixtures of chromium and copper, mixtures of chromium and iron and manganese, mixtures of nickel and iron, mixtures of nickel and manganese, mixtures of nickel and cobalt, mixtures of nickel and titanium, mixtures of nickel and cobalt and chromium, mixtures of nickel and cobalt and chromium and manganese, mixtures of nickel and chromium and manganese, chromium, nickel, copper;
the perovskite content in said oxide pigment as oxide(s) of perovskite structure is greater than 90%, preferably greater than 95%, preferably greater than 99%. Preferably, said perovskite content is substantially equal to 100%.

In a second embodiment, the oxide pigment consists for more than 95%, preferably for more than 97%, preferably for more than 98%, preferably for more than 99% of its mass of an oxide of spinel structure CD₂O₄ or D(C,D)O₄ and the particle mixture according to the invention may also include one or more of the following optional features:
said spinel is chosen from an iron-chromium spinel, an iron-cobalt spinel, an iron-chromium-cobalt spinel, a cobalt-magnesium-zinc-chromium spinel, a cobalt-nickel-iron-chromium spinel, a nickel-manganese-iron-chromium spinel, a zinc-manganese-chromium-iron spinel, a manganese-iron spinel, a chromium-iron-nickel spinel, a cobalt-chromium spinel, a copper-chromium spinel, a cobalt-titanium spinel, an iron-titanium spinel, a zinc-iron spinel, a zinc-iron-chromium spinel, a cobalt-tin spinel, a nickel-iron spinel, an iron-manganese-chromium spinel, a zinc-manganese-chromium spinel, and mixtures thereof.
preferably, said spinel is chosen from an iron-chromium spinel, an iron-cobalt spinel, an iron-chromium-cobalt spinel, a cobalt-nickel-iron-chromium spinel, a nickel-manganese-iron-chromium spinel, a manganese-iron spinel, a chromium-iron-nickel spinel, a copper-chromium spinel, and mixtures thereof, preferably chosen from an iron-chromium spinel, an iron-cobalt spinel, an iron-chromium-cobalt spinel, and mixtures thereof;
preferably, said spinel is chosen from an iron-chromium spinel having a mass ratio of iron expressed as Fe₂O₃ to chromium expressed as Cr₂O₃, Fe₂O₃/Cr₂O₃ of greater than 0.3, preferably greater than 0.7, preferably greater than 1 and preferably less than 3, an iron-cobalt spinel having a mass ratio of iron expressed as Fe₂O₃ to cobalt expressed as Co₃O₄, Fe₂O₃/Co₃O₄ of greater than 0.5, preferably greater than 1, preferably greater than 1.5 and preferably less than 4, an iron-chromium-cobalt spinel having a mass ratio of iron expressed as Fe₂O₃ to chromium expressed as Cr₂O₃, Fe₂O₃/Cr₂O₃ of greater than 0.5, preferably greater than 1, preferably greater than 1.3 and preferably less than 3, preferably less than 2.5, preferably less than 2, and a mass ratio of iron expressed as Fe₂O₃ to cobalt expressed as Co₃O₄, Fe₂O₃/Co₃O₄ greater than 0.5, preferably greater than 1 and preferably less than 3, preferably less than 2.5, preferably less than 2, preferably less than 1.5, and mixtures thereof;
the element C of the spinel structure is chosen from the group G_{C}(1) formed by nickel Ni in a mole fraction of between 0 and 0.2 or in a mole fraction equal to 1, copper Cu in a mole fraction of between 0 and 0.2, iron Fe in a mole fraction of between 0.2 and 0.6 or in a mole fraction equal to 1, zinc Zn in a mole fraction of between 0 and 0.2 or in a mole fraction equal to 1, manganese Mn in a mole fraction of between 0 and 0.4, cobalt Co in a mole fraction of between 0 and 0.4 or in a mole fraction of between 0.4 and 1, tin Sn in a mole fraction of between 0 and 0.2 or in a mole fraction equal to 1, mixtures of zinc and iron, mixtures of iron and manganese, mixtures of zinc and manganese, mixtures of cobalt and zinc, and mixtures thereof;
preferably, the element C is chosen from the group G_{C}(2) formed by nickel Ni in a mole fraction of between 0 and 0.2 or in a mole fraction equal to 1, iron Fe in a mole fraction of between 0.2 and 0.6 or in a mole fraction equal to 1, zinc Zn in a mole fraction equal to 1, manganese Mn in a mole fraction of between 0 and 0.4, cobalt Co in a mole fraction of between 0 and 0.4 or in a mole fraction of between 0.4 and 1, tin Sn in a mole fraction of between 0 and 0.2 or in a mole fraction equal to 1, mixtures of zinc and iron, mixtures of iron and manganese, mixtures of zinc and manganese, mixtures of cobalt and zinc, and mixtures thereof;
the element D of the spinel structure is chosen from the group G_{D}(1) formed by manganese Mn in a mole fraction of between 0 and 0.4, iron Fe in a mole fraction of between 0 and 0.6 or in a mole fraction equal to 1 (i.e. D is the element Fe), chromium Cr in a mole fraction of between 0.2 and 0.6 and in a mole fraction equal to 1, titanium Ti in a mole fraction of between 0 and 1, cobalt in a mole fraction equal to 1 unless the element C is cobalt, mixtures of iron and chromium, mixtures of iron and chromium and manganese, mixtures of manganese and chromium, and mixtures thereof;
preferably, the element D is chosen from the group G_{D}(2) formed by manganese Mn in a mole fraction of between 0 and 0.4, iron Fe in a mole fraction of between 0.2 and 0.6 and in a mole fraction equal to 1, chromium Cr in a mole fraction of between 0 and 0.6 and in a mole fraction equal to 1, titanium Ti in a mole fraction equal to 1, cobalt in a mole fraction equal to 1 except if the element C is cobalt, mixtures of iron and chromium, mixtures of iron and chromium and manganese, mixtures of manganese and chromium, and mixtures thereof;
the spinel content in the 0.5% to 10% of pigment as oxide(s) of spinel structure is greater than 90%, preferably greater than 95%, preferably greater than 99%; preferably, said spinel content is substantially equal to 100%;
in one embodiment, the precursor of said oxide pigment of spinel structure is a compound consisting of an intimate mixture of the oxides and/or precursors of the oxides of which said oxide of spinel structure is composed; such an intimate mixture may be obtained, for example, by co-precipitation or atomization, preferably consolidated by a heat treatment;
in a preferred embodiment, the particle mixture does not contain any precursor of said oxide pigment of spinel structure.

In a third embodiment, the oxide pigment consists for more than 95%, preferably for more than 97%, preferably for more than 98%, preferably for more than 99% of its mass of an oxide of hematite structure E₂O₃, the element E being chosen from the group G_{E}(1) formed by iron, chromium and a mixture of iron and chromium. Preferably, the hematite content in the 0.5% to 10% of pigment as oxide(s) of hematite structure is greater than 90%, preferably greater than 95%, preferably greater than 99%. Preferably, the hematite content in said pigment is substantially equal to 100%.

In a fourth embodiment, the oxide pigment consists for more than 95%, preferably for more than 97%, preferably for more than 98%, preferably for more than 99% of its mass of an oxide of rutile structure FO₂, the element F being chosen from the group G_{F}(1) formed by mixtures of tin and vanadium, mixtures of titanium and chromium and niobium, mixtures of titanium and chromium and tungsten, mixtures of titanium and niobium and manganese, mixtures of tin and chromium, mixtures of chromium and titanium and antimony, mixtures of nickel and antimony and titanium, and mixtures thereof. Preferably, the rutile content in the 0.5% to 10% of oxide pigment as oxide(s) of rutile structure is greater than 90%, preferably greater than 95%, preferably greater than 99%. Preferably, the rutile content in said oxide pigment is substantially equal to 100%.

In one embodiment, the oxide pigment is a mixture of several oxide pigments according to the first to fourth embodiments above.

When the color black is desired for the sintered product to be manufactured, a particle mixture according to the invention preferably includes an oxide pigment consisting for more than 95%, preferably for more than 97%, preferably for more than 98%, preferably for more than 99% of its mass of an oxide of spinel structure chosen from an iron-chromium spinel, an iron-cobalt spinel, an iron-chromium-cobalt spinel, a cobalt-nickel-iron-chromium spinel, a nickel-manganese-iron-chromium spinel, a manganese-iron spinel, a chromium-iron-nickel spinel, a copper-chromium spinel, and mixtures thereof, preferably chosen from an iron-chromium spinel, an iron-cobalt spinel, an iron-chromium-cobalt spinel, and mixtures thereof.

Preferably, said spinel is chosen from an iron-chromium spinel having a mass ratio of iron expressed as Fe₂O₃ to chromium expressed as Cr₂O₃, Fe₂O₃/Cr₂O₃ of greater than 0.3, preferably greater than 0.7, preferably greater than 1 and preferably less than 3, an iron-cobalt spinel having a mass ratio of iron expressed as Fe₂O₃ to cobalt expressed as Co₃O₄, Fe₂O₃/Co₃O₄ of greater than 0.5, preferably greater than 1, preferably greater than 1.5 and preferably less than 4, an iron-chromium-cobalt spinel having a mass ratio of iron expressed as Fe₂O₃ to chromium expressed as Cr₂O₃, Fe₂O₃/Cr₂O₃ of greater than 0.5, preferably greater than 1, preferably greater than 1.3 and preferably less than 3, preferably less than 2.5, preferably less than 2 and a mass ratio of iron expressed as Fe₂O₃ to cobalt expressed as Co₃O₄, Fe₂O₃/Co₃O₄ of greater than 0.5, preferably greater than 1 and preferably less than 3, preferably less than 2.5, preferably less than 2, preferably less than 1.5, and mixtures thereof.

Preferably, the content of said oxide of spinel structure is greater than 3%, preferably greater than 4% and preferably less than 9%, preferably less than 8%, as a mass percentage on the basis of the mass of the oxides.

The “other oxides” that are not included in the oxide pigment are preferably impurities. They preferably represent less than 1.5%, preferably less than 1%, more preferably less than 0.5%, preferably less than 0.2%, preferably less than 0.1%, as a mass percentage on the basis of the oxides.

A particle mixture according to the invention may also include one or more deflocculant(s) and/or binder(s) and/or lubricant(s), which are preferably temporary, conventionally used in forming processes for the manufacture of preforms to be sintered, for example an acrylic resin, polyethylene glycol (PEG), or polyvinyl alcohol (PVA).

Specific Surface Area and Median Size

Preferably, the particle mixture according to the invention has a median size (D₅₀) of less than 2 μm, preferably less than 1.5 μm, preferably less than 1 μm, preferably less than 0.8 μm, preferably less than 0.6 μm, preferably less than 0.5 μm, preferably less than 0.4 μm, preferably less than 0.3 μm and/or preferably greater than 0.05 μm.

Preferably, the particle mixture has a ratio (D₉₀-D₁₀)/D₅₀ of less than 2, preferably less than 1.5.

Preferably, the particle mixture has a specific surface area, calculated via the BET method, of greater than 5 m²/g and/or preferably less than 20 m²/g, preferably less than 15 m²/g.

The particle mixture may be in dry form, i.e. obtained directly by mixing the appropriate starting materials. It may also have undergone an additional step, for example an atomization step, notably to improve its chemical homogeneity.

In a preferred embodiment, the particle mixture according to the invention has the following chemical composition, as mass percentages on the basis of the oxides:
ZrO₂+HfO₂+Y₂O₃+CeO₂: the remainder to 100%;
0% Al₂O₃≤1.5%, preferably greater than or equal to 0.2%, preferably greater than or equal to 0.25% and preferably less than or equal to 1.2%, preferably less than or equal to 1%, preferably less than or equal to 0.8%;
“other oxides”: 3% to 9%,

the contents of Y₂O₃ and CeO₂, as molar percentages on the basis of the sum of ZrO₂, HfO₂, Y₂O₃ and CeO₂, being such that the Y₂O₃ content is greater than or equal to 1.9%, preferably greater than or equal to 2% and/or preferably less than or equal to 2.5%, preferably less than or equal to 2.4%, preferably less than or equal to 2.2%, and the CeO₂ content is greater than or equal to 0.2%, preferably greater than or equal to 0.3%, preferably greater than or equal to 0.4% and less than 0.8%, preferably less than 0.7%, preferably less than 0.6%; and the particle mixture includes, as a mass percentage on the basis of the particle mixture, between 3% and 7% of an oxide pigment consisting for more than 95%, preferably for more than 97%, preferably for more than 98%, preferably for more than 99% of its mass of an oxide of spinel structure chosen from an iron-chromium spinel, an iron-cobalt spinel, an iron-chromium-cobalt spinel, a cobalt-nickel-iron-chromium spinel, a nickel-manganese-iron-chromium spinel, a manganese-iron spinel, a chromium-iron-nickel spinel, a copper-chromium spinel, and mixtures thereof, preferably chosen from an iron-chromium spinel, an iron-cobalt spinel, an iron-chromium cobalt spinel, and mixtures thereof,

the content of oxides which are “other oxides” and which are not included in the oxide pigment, preferably the content of impurities, being less than 2%, preferably less than 1.5%, preferably less than 1%, more preferably less than 0.5%, preferably less than 0.2%, preferably less than 0.1% as a mass percentage on the basis of the oxides.

In this embodiment, the oxides which constitute the oxide pigment are thus counted as “other oxides”.

Preferably, said spinel is chosen from an iron-chromium spinel having a mass ratio of iron expressed as Fe₂O₃ to chromium expressed as Cr₂O₃, Fe₂O₃/Cr₂O₃ of greater than 0.3, preferably greater than 0.7, preferably greater than 1 and preferably less than 3, an iron-cobalt spinel having a mass ratio of iron expressed as Fe₂O₃ to cobalt expressed as Co₃O₄, Fe₂O₃/Co₃O₄ of greater than 0.5, preferably greater than 1, preferably greater than 1.5 and preferably less than 4, an iron-chromium-cobalt spinel having a mass ratio of iron expressed as Fe₂O₃ to chromium expressed as Cr₂O₃, Fe₂O₃/Cr₂O₃ of greater than 0.5, preferably greater than 1, preferably greater than 1.3 and preferably less than 3, preferably less than 2.5, preferably less than 2 and a mass ratio of iron expressed as Fe₂O₃ to cobalt expressed as Co₃O₄, Fe₂O₃/Co₃O₄ of greater than 0.5, preferably greater than 1 and preferably less than 3, preferably less than 2.5, preferably less than 2, preferably less than 1.5, and mixtures thereof.

In said preferred embodiment, the particle mixture has a median size (D50) of less than 2 μm, preferably less than 1.5 μm, preferably less than 1 μm, preferably less than 0.8 μm, preferably less than 0.6 μm, preferably less than 0.5 μm, preferably less than 0.4 μm, preferably less than 0.3 μm and/or preferably greater than 0.05 μm, and a ratio (D₉₀-D₁₀)/D₅₀ of less than 2, preferably less than 1.5.

Process for Manufacturing the Particle Mixture

The particle mixture according to the invention may be conventionally obtained by, for example, mixing starting materials.

Grinding may be necessary to obtain a particle mixture with a median size of less than 2.0 μm.

In particular, the starting material powders providing the oxides may be ground individually or, preferably, co-milled, if they do not meet the desired particle size distribution. The grinding may be performed by wet grinding, for example in an attrition mill. After wet grinding, the ground particle mixture is preferably dried.

Preferably, the powders used, notably the zirconia ZrO₂, alumina Al₂O₃, yttria Y₂O₃, ceria CeO₂, and oxide pigment powders, each have a median size of less than 5 μm, less than 3 μm, less than 2 μm, less than 1 μm, less than 0.7 μm, preferably less than 0.6 μm, preferably less than 0.5 μm. Advantageously, when each of these powders has a median size of less than 2 μm, preferably less than 1 μm, preferably less than 0.8 μm, preferably less than 0.6 μm, preferably less than 0.5 μm, or even less than 0.3 μm, or even less than 0.2 μm, grinding is optional.

The use of powders with a small median size also makes it possible, advantageously, to reduce the sintering temperature.

These powders may also be replaced, at least partially, with powders of precursors of these oxides, introduced in equivalent amounts.

Preferably, the zirconia powder used has a specific surface area, calculated via the BET method, of greater than 5 m²/g, preferably greater than 6 m²/g, and less than 20 m²/g, preferably less than 15 m²/g. Advantageously, the sintering temperature in step d) is reduced. The grinding, generally in suspension, and slurrying are also thereby facilitated. Preferably, an alumina powder, preferably corundum, is used.

The powders providing the oxides or precursors are preferably chosen so that the total impurity content is less than 2%, as a mass percentage on the basis of the oxides.

A particle mixture according to the invention may also include one or more deflocculant(s) and/or binding agent(s) and/or lubricant(s), which are preferably temporary, conventionally used in forming processes for the manufacture of preforms to be sintered, for example an acrylic resin, polyethylene glycol (PEG), or polyvinyl alcohol (PVA).

Advantageously, such a particle mixture is ready to use.

A particle mixture according to the invention may in particular be packaged in bags.

Intermediate Product

The particle mixture according to the invention is preferably placed in an intermediate form suitable for its intended use.

The particle mixture according to the invention may in particular be placed in the form of a feed powder generally in the form of granules or “pellets”, known as a feedstock, more particularly intended for forming by injection molding, in the form of a printing paste more particularly intended for forming by 3D printing or in the form of a granule powder more particularly intended for forming by pressing. Preferably, the granule powder has a median size greater than 1 mm and less than 8 mm. Preferably, the granule powder has a median size greater than 20 μm and less than 100 μm.

All the conventional processes may be used for the intermediate forming of the particle mixture according to the invention.

The particle mixture according to the invention, or the intermediate product resulting from its intermediate forming (granules, printing paste, pellets, etc.), is preferably packaged, for example in bags, jars, drums or buckets, to be ready for use.

Process for Manufacturing a Sintered Colored Zirconia Product According to the Invention

The process for manufacturing, according to the invention, a sintered colored zirconia product includes steps a) and b) described above.

In step a), a starting feedstock suitable for the manufacture of a sintered colored zirconia product is prepared.

The starting feedstock includes a particle mixture according to the invention, optionally in the form of an intermediate product according to the invention, and optional constituents.

The amount of the optional constituents is preferably greater than 0.1% and/or less than 70%, as a mass percentage on the basis of the mass of the dry starting feedstock, the particle mixture according to the invention and/or the intermediate product according to the invention constituting the remainder to 100% of the dry starting feedstock.

Depending on the process used for the forming, a solvent, preferably water, may be added to the starting feedstock.

The optional constituents are the constituents conventionally used for the manufacture of sintered ceramic products. In particular, they comprise organic constituents.

In one embodiment, in particular when the forming process in step b) is slip casting, the organic constituents are preferably chosen from dispersants, viscosity modifiers, antifoam agents, and mixtures thereof, in an amount preferably greater than 0.1% and less than 5%, as a mass percentage on the basis of the mass of the dry starting feedstock.

In one embodiment, in particular when the forming process in step b) is pressing, the organic constituents are preferably chosen from binders, lubricants, resins, plasticizers, in an amount preferably greater than 0.2% and less than 10%, as a mass percentage on the basis of the mass of the dry starting feedstock.

In one embodiment, particularly when the forming process in step b) is a plastic injection molding process, the organic constituents are preferably chosen from surfactants, waxes, polymers, resins, plasticizers, and mixtures thereof, in an amount preferably greater than 25% and less than 65%, as a mass percentage on the basis of the mass of the dry starting feedstock.

In one embodiment, particularly when the particle mixture according to the invention is in the form of an intermediate product according to the invention, no organic constituents are added to the starting feedstock.

In step b), the forming of the starting feedstock including a particle mixture according to the invention, optionally in the form of an intermediate product, may be performed conventionally, via any technique known to those skilled in the art, in particular by slip casting, by pressing, notably uniaxial pressing or cold isostatic pressing, by injection molding, notably by plastic injection molding or by printing, notably by 3D printing.

Preferably, the pressure applied during uniaxial pressing is greater than 40 MPa and preferably less than or equal to 150 MPa.

A preform is thus obtained.

In step c), the preform is sintered, preferably under oxidizing conditions, preferably in air, preferably at atmospheric pressure or under pressure (hot pressing or hot isostatic pressing, or HIP), preferably at atmospheric pressure. Preferably, the preform is sintered at a temperature above 1350° C. and/or preferably below 1600° C., preferably below 1550° C., preferably below 1500° C., preferably below 1450° C., so as to obtain a sintered colored zirconia product.

Sintering under oxidizing conditions advantageously avoids conversion of the CeO₂ into Ce₂O₃, which modifies the coloration obtained.

The maintenance time at the temperature steady stage is preferably more than 1 hour and/or preferably less than 10 hours, preferably less than 7 hours, preferably less than 5 hours, preferably less than 3 hours. Preferably, the sintering time is between 1 and 3 hours.

The temperature increase rate is conventionally between 10 and 100° C./hour. The temperature decrease rate may be free. If organic constituents, notably deflocculants and/or binders and/or lubricants are used, the sintering cycle preferably comprises a steady stage of 1 to 4 hours at a temperature of between 300° C. and 600° C. so as to promote the removal of said products.

The sintered colored zirconia product obtained at the end of step c) may be machined and/or may undergo a surface treatment, for instance polishing or sandblasting, according to any technique known to those skilled in the art.

Sintered Colored Zirconia Product According to the Invention

A sintered colored zirconia product according to the invention may be manufactured by means of a manufacturing process according to the invention.

Surprisingly, and without being able to explain it theoretically, the inventors have discovered that the simultaneous presence of Y₂O₃ and CeO₂, in the contents present in the invention, makes it possible to achieve an excellent compromise between toughness and resistance to hydrothermal aging.

The composition of a sintered product according to the invention may be identical to that of a particle mixture according to the invention, not considering the temporary constituents, in particular, considering only the oxides. In particular, the amount of the various constituents and the nature of the oxide pigment are identical to those described above for the particle mixture.

In the sintered colored zirconia product according to the invention, the zirconia is at least partially stabilized with Y₂O₃ and CeO₂. Preferably, the monoclinic zirconia fraction is less than 10%, preferably less than 5%, preferably less than 1%. Preferably, the zirconia is fully stabilized with Y₂O₃ and CeO₂, preferably substantially fully in the quadratic form.

Preferably, the sintered colored zirconia product according to the invention has less than 5%, preferably less than 1%, or has substantially no cerium in the form of Ce₂O₃, as a mass percentage on the basis of the cerium. Advantageously, the color of the sintered product according to the invention is close to the desired color.

The sintered colored zirconia product according to the invention preferably consists for more than 98%, preferably more than 99%, preferably more than 99.5%, preferably more than 99.9%, or even substantially 100% of oxides.

The sintered colored zirconia product according to the invention has an average grain size of less than 2 μm, preferably less than 1.5 μm, preferably less than 1 μm, preferably less than 0.9 μm, preferably less than 0.8 μm, preferably less than 0.6 μm, preferably less than 0.5 μm, and preferably greater than 0.1 μm, preferably greater than 0.2 μm. Advantageously, a better compromise between toughness and resistance to hydrothermal aging is obtained. Preferably, the sintered colored zirconia product according to the invention has a grain size distribution with a standard deviation of less than 0.15 μm, preferably less than 0.1 μm. The grains of the oxide pigment of the sintered colored zirconia product according to the invention include, preferably consist for more than 95%, preferably for more than 97%, preferably for more than 98%, preferably for more than 99% of its mass of a material chosen from:
oxide(s) of perovskite structure,
oxides of spinel structure,
oxides of hematite structure E₂O₃, the element E being chosen from the group G_{E}(1) formed by iron, chromium and a mixture of iron and chromium,
oxides of rutile structure FO₂, the element F being chosen from the group G_{F}(1) formed by mixtures of tin and vanadium, mixtures of titanium and chromium and niobium, mixtures of titanium and chromium and tungsten, mixtures of titanium and niobium and manganese, mixtures of tin and chromium, mixtures of chromium and titanium and antimony, mixtures of nickel and antimony and titanium, and mixtures thereof,
and mixtures thereof.

In a preferred embodiment, the sintered colored zirconia product according to the invention is black in color and has the following chemical composition, as mass percentages on the basis of the oxides:
ZrO₂+HfO₂+Y₂O₃+CeO₂: the remainder to 100%;
0% Al₂O₃≤1.5%, preferably greater than or equal to 0.2%, preferably greater than or equal to 0.25% and preferably less than or equal to 1.2%, preferably less than or equal to 1%, preferably less than or equal to 0.8%;
oxides other than ZrO₂, HfO₂, Y₂O₃, CeO₂ and Al₂O₃, or “other oxides”: between 3% and 9%;

the contents of Y₂O₃ and CeO₂, as molar percentages on the basis of the sum of ZrO₂, HfO₂, Y₂O₃ and CeO₂, being such that the Y₂O₃ content is greater than or equal to 1.9%, preferably greater than or equal to 2% and/or preferably less than or equal to 2.5%, preferably less than or equal to 2.4%, preferably less than or equal to 2.2%, and the CeO₂ content is greater than or equal to 0.2%, preferably greater than or equal to 0.3%, preferably greater than or equal to 0.4% and less than 0.8%, preferably less than 0.7%, preferably less than 0.6%; and the particle mixture includes, as a mass percentage on the basis of the particle mixture, between 3% and 7% of an oxide pigment consisting for more than 95%, preferably for more than 97%, preferably for more than 98%, preferably for more than 99% of its mass of an oxide of spinel structure chosen from an iron-chromium spinel, an iron-cobalt spinel, an iron-chromium-cobalt spinel, a cobalt-nickel-iron-chromium spinel, a nickel-manganese-iron-chromium spinel, a manganese-iron spinel, a chromium-iron-nickel spinel, a copper-chromium spinel, and mixtures thereof, preferably chosen from an iron-chromium spinel, an iron-cobalt spinel, an iron-chromium-cobalt spinel, and mixtures thereof, the content of oxides which are “other oxides” and which are not included in the oxide pigment, preferably the content of impurities, being less than 2%, preferably less than 1.5%, preferably less than 1%, more preferably less than 0.5%, preferably less than 0.2%, preferably less than 0.1% as a mass percentage on the basis of the oxides. In this embodiment, the oxides that constitute the oxide pigment are thus counted as “other oxides”.

Preferably, said spinel is chosen from an iron-chromium spinel having a mass ratio of iron expressed as Fe₂O₃ to chromium expressed as Cr₂O₃, Fe₂O₃/Cr₂O₃ of greater than 0.3, preferably greater than 0.7, preferably greater than 1 and preferably less than 3, an iron-cobalt spinel having a mass ratio of iron expressed as Fe₂O₃ to cobalt expressed as Co₃O₄, Fe₂O₃/Co₃O₄ of greater than 0.5, preferably greater than 1, preferably greater than 1.5 and preferably less than 4, an iron-chromium-cobalt spinel having a mass ratio of iron expressed as Fe₂O₃ to chromium expressed as Cr₂O₃, Fe₂O₃/Cr₂O₃ of greater than 0.5, preferably greater than 1, preferably greater than 1.3 and preferably less than 3, preferably less than 2.5, preferably less than 2 and a mass ratio of iron expressed as Fe₂O₃ to cobalt expressed as Co₃O₄, Fe₂O₃/Co₃O₄ greater than 0.5, preferably greater than 1 and preferably less than 3, preferably less than 2.5, preferably less than 2, preferably less than 1.5, and mixtures thereof.

The oxides preferably represent more than 98%, preferably more than 99%, preferably more than 99.5%, preferably more than 99.9%, or even substantially 100% of the mass of such a black sintered zirconia product.

In said preferred embodiment, the sintered colored zirconia product has an average grain size of less than 2 μm, preferably less than 1.5 μm, preferably less than 1 μm, preferably less than 0.9 μm, preferably less than 0. 8 μm, preferably less than 0.6 μm, preferably less than 0.5 μm, and preferably greater than 0.1 μm, preferably greater than 0.2 μm, and a grain size distribution with a standard deviation of less than 0.15 μm, preferably less than 0.1 μm.

Preferably, the sintered colored zirconia product according to the invention has a relative density greater than 99.5%, preferably greater than 99.6%, preferably greater than 99.7%, preferably greater than 99.8%, preferably greater than 99.9%, the absolute density being calculated according to the method described previously.

Preferably, in particular when it has a black color, the sintered colored zirconia product according to the invention has a bulk density of greater than 5.98 g/cm³, preferably greater than 5.99 g/cm³, preferably greater than 6.00 g/cm³ and preferably less than 6.02 g/cm³.

Preferably, the sintered colored zirconia product according to the invention has a toughness of greater than 12 MPa·m^{1/2}, preferably greater than 13 MPa·m^{1/2}, preferably greater than 13.5 MPa·m^{1/2}.

Device According to the Invention

The invention finally relates to a device chosen from the group consisting of an item of jewelry, a watch, a bracelet, a necklace, a ring, a brooch, a tie pin, a handbag, a telephone, an item of furniture, a household utensil, a handle, a switch, a button, a plating, a visible part of a consumer goods equipment, a part of an spectacle frame, a tableware article, a welding pin and a frame, said device including a part of a sintered colored zirconia product according to the invention or made from a particle mixture according to the invention.

Preferably, the sintered zirconia product is a black colored product as described above.

Said device may have a support onto which a part made of a sintered colored zirconia product according to the invention is bonded, clipped, sewn, or forcefully inserted. Said part may also be co-sintered with its support.

In one embodiment, the device is packaged, for example in a bag, box, or container, for example in a package including, or even consisting of, paper and/or cardboard and/or plastic or metal, preferably as foil, preferably as flexible foil. Preferably, the packaging bears information specifying the intended use of the device and/or technical features of the device.

### EXAMPLES

The following nonlimiting examples are given for the purpose of illustrating the invention.

Measurement Protocols

The following methods were used to determine certain properties of particle mixtures and sintered products obtained from said particle mixtures. They allow an excellent simulation of the real behavior in service.

The bulk density of the sintered products is measured by hydrostatic weighing.

The unit cell parameters required for calculating the absolute density of the at least partially stabilized zirconia are determined by X-ray diffraction on the surface of the sample to be characterized (the sample not being ground in the form of a powder) by means of a D8 Endeavor machine from the company Broker. The parameters required for the acquisition of the diffraction pattern are identical to those used for the acquisition of the diffraction pattern required for the determination of the monoclinic zirconia fraction.

The unit cell parameters a and c are determined after having performed a refinement of the diffraction pattern using the Fullprof software available from https://www.ill.eu/sites/fullprof/, using a pseudo-Voigt profile (with npr=5), the refined parameters being as follows:
the sample displacement using the “SyCos” function,
the Lorentzian/Gaussian proportion of the pseudo-Voigt function using the “Shape 1” function,
the width parameters at half height U, V, W,
the skewness parameters using the “Asy1” and “Asy2” functions,
the points of the baseline,

the space group of the partially substituted quadratic zirconia unit cell being P 42/n m c (137), considered identical to that of the non-substituted quadratic zirconia unit cell.

The chemical analysis of the sintered products is measured by “Inductively Coupled Plasma” (ICP) spectrometry, for the elements whose content does not exceed 0.5%. To determine the content of other elements, a bead of the product to be analyzed is made by melting the product, and the chemical analysis is then performed by X-ray fluorescence.

The average grain size of the sintered products is measured by means of the Mean Linear Intercept method. A method of this type is described in the standard ASTM E1382. According to this standard, analysis lines are drawn on images of the sintered products, and then, along each analysis line, the lengths, called “intercepts”, between two consecutive grain boundaries intersecting said analysis line are measured.

The average length “I′” of the intercepts “I” is then determined.

For the tests below, the intercepts were measured on images, obtained by scanning electron microscopy, of sintered product samples, said sections having been polished beforehand to mirror quality and then thermally etched, at a temperature 50° C. below the sintering temperature, to reveal the grain boundaries. The magnification used to take the images is chosen so as to visualize approximately 100 grains on one image. Five images per sintered product were taken.

The average size “d” of the grains of a sintered product is given by the relationship: d=1.56.I′. This formula is derived from formula (13) of the article “Average Grain Size in Polycrystalline Ceramics”, M. I. Mendelson, J. Am. Ceram. Soc., Vol. 52, No. 8, pages 443-446.

The standard deviation of the grain size distribution is 1.56 times the standard deviation of the intercept distribution “I”.

The specific surface area of a powder is measured via the BET (Brunauer Emmett Teller) method described in the Journal of the American Chemical Society, 60 (1938), pages 309 to 316.

The 10, 50 and 90 percentiles of powders and particle mixtures are conventionally measured using an LA950V2 model laser granulometer sold by the company Horiba.

The average size of the stabilized zirconia crystallites, D, of a zirconia powder is determined by X-ray diffraction on the surface of the sample to be characterized (the sample not being ground in the form of a powder) using a D8 Endeavor machine from the company Brüker, by means of the following equation:

$$D = \frac{K λ}{\sqrt{( {B}^{2} - {b}^{2} )} cos θ} ⨯ \frac{1}{10} ⨯ \frac{180}{π} \qquad [ Math 1 ]$$

K being equal to 0.89, A being the X-ray wavelength, in this case equal to 1.5418 Ångströms, B being the width at half-height of the peak of the (111) plane of the stabilized zirconia, in degrees, b being the width at half-height of the peak of the single-crystal silicon standard used, and 2θ being the angle of the maximum intensity of the peak corresponding to the (111) plane of the stabilized zirconia, in degrees.

The diffraction patterns of the single-crystal silicon standard and of the example are acquired, over an angular range 2θ between 5° and 100°, with a step size of 0.01°, and a counting time of 0.34 s/step. The front optics include a 0.3° primary slit and a 2.5° Soller slit. The characterized sample is rotating on itself at a speed equal to 15 rpm, using the automatic knife. The rear optics include a 2.5° Soller slit, a nickel filter of 0.0125 mm and a 1D detector with an aperture equal to 4°.

After removing the Kα2 line, the width at half-height of the peaks is determined using the HighScore Plus software. The deconvolution function used is a pseudo-Voigt with a Split Width skewness. The standard and the samples are deconvolved under the same conditions.

The resistance to hydrothermal aging of the sintered products of the examples is evaluated by the following method.

Each sample, in the form of a disk with a diameter of 25 mm and a thickness of 2 mm, is polished on one of the large faces using an abrasive paper disk with an abrasive particle size of 3 μm. The polishing is performed in such a way that no monoclinic zirconia is generated on the polished surface.

The polished samples are then subjected to an accelerated aging test according to the following protocol: the samples are placed in a Teflon crucible with a diameter equal to 80 mm and a capacity equal to 0.5 liter. Said crucible is placed in an autoclave with a diameter of 100 mm and a capacity of 1 liter. 100 ml of water are added to the autoclave, outside the crucible. The autoclave is closed and the system is heated at 135° C. for 5 hours, at the autogenous pressure.

Before testing, all the sintered products in the examples are completely stabilized. Measurement of the monoclinic zirconia fraction, as described previously, on the autoclaved samples thus directly gives a measure of the resistance to hydrothermal aging.

The toughness of the sintered products of the examples is approximated by the value of the resistance to fracture by indentation, according to the standard ISO 14627, on disks with a diameter equal to 32 mm and a thickness equal to 3 mm, the number of disks per product to be tested being equal to 3, the surface on which the indentation is performed being polished so that it has a roughness Ra<0.1 μm, the measurements being taken at room temperature, with the application of a force equal to 98 N for a time equal to 15 seconds, five indentations being made per disc, the value of the modulus of elasticity being equal to 205 GPa.

The color parameters (L, a* and b*) are measured according to the standard NF ISO 7724 on polished parts, the last step of polishing having been performed with a Mecaprex LD32-E 1 μm diamond preparation sold by the company PRESI, using a CM-2500d machine, manufactured by the company Konica-Minolta, with illuminant D65 (natural light), observer at 10°, and specular reflection excluded.

Manufacturing Protocol

Sintered products were prepared using:
an yttriated zirconia powder with a molar content of Y₂O₃ equal to 3%, having a specific surface area of the order of 10 m²/g and a median size of less than 0.3 μm for example 1,
an yttriated zirconia powder with a molar content of Y₂O₃ equal to 2%, having a specific surface area of the order of 10 m²/g and a median size of less than 0.3 μm for examples 2 to 5,
a ceria CeO₂ powder with a purity of greater than 99% and a median size of less than 10 μm for examples 3 to 5,
an alumina powder with a purity of greater than 99% and a median size of less than 0.5 μm for examples 1 to 5,
an oxide pigment powder consisting of iron-cobalt-chromium spinel, for examples 1 to 5, with a median size equal to 1.4 μm and having a mass content of iron oxide, expressed as Fe₂O₃, equal to 40%, a mass content of cobalt oxide expressed as Co₃O₄ equal to 31% and a mass content of chromium oxide expressed as Cr₂O₃ equal to 27%, the mass content of impurities being equal to 2%.

These powders were mixed and then wet co-milled until a particle mixture was obtained with a median particle size of less than 0.5 μm. Polyvinyl alcohol was then added in an amount equal to 2% on the basis of the dry matter of the particle mixture. The starting feedstock obtained was then atomized in a spray dryer in the form of a powder of granules with a median size equal to 60 μm, a relative density of between 30% and 60% and a sphericity index of greater than 0.85, the relative density of a granule powder being the ratio equal to the real density divided by the absolute density, expressed as a percentage, the absolute density of a granule powder being the ratio equal to the dry matter mass of said powder after grinding to a fineness such that substantially no closed pores remain, divided by the volume of that mass after grinding, measured by helium pycnometry, and the real density of a granule powder being the average of the bulk densities of each granule of the powder, the bulk density of a granule being the ratio equal to the mass of said granule divided by the volume occupied by said granule.

In step b), each granule powder was then pressed on a uniaxial press at a pressure equal to 100 MPa.

In step c), the preforms obtained were then transferred into a sintering furnace where they were heated, at a rate of 100° C./hour, to 1400° C. The temperature of 1400° C. was maintained for 2 hours. The temperature decrease was performed by natural cooling.

Tables 1, 2 and 3 below summarize the composition of the particle mixtures used in step a), their features and the features of the sintered products obtained, respectively.

TABLE 1

| | Particle mixtures used | | | | |
|---|---|---|---|---|---|
| | in the examples (mass %) | | | | |
| Powders | 1(*) | 2(*) | 3 | 4 | 5(*) |
| Zirconia containing 3 mol % Y₂O₃ | 94.7 | — | — | — | — |
| Zirconia containing 2 mol % Y₂O₃ | — | 94.9 | 94.1 | 94 | 93.7 |
| Al₂O₃ | 1.1 | 1.0 | 1.0 | 0.9 | 1.0 |
| CeO₂ | — | — | 0.7 | 1 | 1.3 |
| Iron-cobalt-chromium spinel | 4.2 | 4.1 | 4.2 | 4.1 | 4.0 |

(*)Example outside the invention

TABLE 2

| Particle mixtures used | | | | |
|---|---|---|---|---|
| in the examples | | | | |
| 1(*) | 2(*) | 3 | 4 | 5(*) |

Chemical analysis as mass percentages on the basis of the oxides

| ZrO₂ + HfO₂ + Y₂O₃+ CeO₂ | The remainder to 100% | | | | |
|---|---|---|---|---|---|
| Al₂O₃ | 1.1 | 1.0 | 1.0 | 0.9 | 1.0 |
| Iron oxide expressed as Fe₂O₃ | 1.7 | 1.6 | 1.7 | 1.6 | 1.6 |
| Cobalt oxide expressed as Co₃O₄ | 1.2 | 1.2 | 1.3 | 1.2 | 1.2 |
| Chromium oxide expressed as Cr₂O₃ | 1.3 | 1.3 | 1.2 | 1.3 | 1.2 |
| Iron-cobalt-chromium spinel | 4.2 | 4.1 | 4.2 | 4.1 | 4.0 |
| Impurities | 0.2 | 0.5 | 0.4 | 0.4 | 0.5 |

Chemical analysis as molar percentages
on the basis of ZrO₂ + HfO₂ + Y₂O₃ + CeO₂

| | | | | | |
|---|---|---|---|---|---|
| Y₂O₃ | 3 | 2 | 2 | 2 | 2 |
| CeO₂ | 0 | 0 | 0.5 | 0.8 | 1 |

Other features of the particle mixture

| | | | | | |
|---|---|---|---|---|---|
| Median size D₅₀ (μm) | 0.23 | 0.25 | 0.22 | 0.24 | 0.23 |
| Ratio (D₉₀ − D₁₀)/D₅₀ | 1.0 | 1.2 | 1.3 | 1.2 | 1.2 |

(*)Example outside the invention

TABLE 3

| Sintered product obtained from the | | | | | |
|---|---|---|---|---|---|
| particle mixture of the example | 1(*) | 2(*) | 3 | 4 | 5(*) |

Chemical analysis as mass percentages on the basis of the oxides

| ZrO₂ + HfO₂ + Y₂O₃ + CeO₂ | The remainder to 100% | | | | |
|---|---|---|---|---|---|
| Al₂O₃ | 1.0 | 1.0 | 1.0 | 1.0 | 1.0 |
| Iron oxide expressed as Fe₂O₃ | 1.7 | 1.6 | 1.7 | 1.6 | 1.6 |
| Cobalt oxide expressed as Co₃O₄ | 1.2 | 1.2 | 1.3 | 1.2 | 1.2 |
| Chromium oxide expressed as Cr₂O₃ | 1.3 | 1.3 | 1.2 | 1.3 | 1.2 |
| Iron-cobalt-chromium spinel | 4.2 | 4.1 | 4.2 | 4.1 | 4.0 |
| Impurities | 0.2 | 0.5 | 0.4 | 0.4 | 0.5 |

Chemical analysis as molar percentages
on the basis of ZrO₂ + HfO₂ + Y₂O₃ + CeO₂

| | | | | | |
|---|---|---|---|---|---|
| Y₂O₃ | 3 | 2 | 2 | 2 | 2 |
| CeO₂ | 0 | 0 | 0.5 | 0.8 | 1 |

Other features of the sintered product

| | | | | | |
|---|---|---|---|---|---|
| Bulk density (g/cm³) | 6.00 | 6.00 | 6.00 | 6.01 | 6.02 |
| Relative density (%) | 99.6 | 99.7 | 99.6 | 99.5 | 99.6 |
| Average grain size (μm) | 0.32 | 0.35 | 0.35 | 0.33 | 0.33 |
| Standard deviation of the grain size | 0.12 | 0.14 | 0.11 | 0.11 | 0.15 |
| Monoclinic zirconia fraction (%) | <5 | <5 | <5 | <5 | <5 |
| Toughness (MPa · m^{1/2}) | 5.5 | 17 | 15 | 12.5 | 11 |
| Resistance to hydrothermal aging | 25 | 52 | 21 | 15 | 10 |
| (monoclinic zirconia fraction | | | | | |
| after the test, in %) | | | | | |

(*)example outside the invention

The particle mixtures of Examples 1-5 and the sintered products obtained from said particle mixtures consist substantially entirely of oxides.

In the particle mixtures of Examples 3-5, as in the sintered products obtained from said particle mixtures, substantially all of the cerium is present in the CeO₂ form.

Examples 1 and 2 are representative of the prior art.

Example 5, outside the invention, is given to serve as a basis for comparison with the examples according to the invention.

When the toughness is greater than or equal to 12 MPa·m^{1/2}, preferably greater than 13 MPa·m^{1/2}, and when the monoclinic zirconia fraction after the aging test as described is less than or equal to 25%, preferably less than or equal to 20%, the product is considered satisfactory.

Examples 1 and 2, which are representative of the prior art, are thus unsatisfactory: Example 1 has a low toughness equal to 5.5 MPa·m^{1/2}, and Example 2 has a low resistance to hydrothermal aging (monoclinic zirconia fraction after the aging test equal to 52%).

Example 5, outside of the invention, shows that a CeO₂ content equal to 1%, as a molar percentage on the basis of ZrO₂+HfO₂+Y₂O₃+CeO₂, does not achieve the objective in terms of toughness: the toughness obtained is in fact equal to 11 MPa·m^{1/2}.

Examples 3 and 4 illustrate the invention. Example 3 is the example that is preferred among all.

As is now clearly seen, the inventors have discovered that the simultaneous presence of a low yttrium oxide content, a low cerium oxide content, and an oxide pigment, in a particle mixture according to the invention, advantageously makes it possible to obtain a sintered colored zirconia product having a toughness of greater than or equal to 12 MPa·m^{1/2} and a monoclinic zirconia fraction after the aging test as described of less than or equal to 25%.

Needless to say, the invention is not limited to the examples and embodiments described above.

1. A particle mixture having the following chemical composition, as mass percentages on the basis of the oxides:
ZrO₂+HfO₂+Y₂O₃+CeO₂: the remainder to 100%;
0%≤Al₂O₃≤1.5%;
oxides other than ZrO₂, HfO₂, Y₂O₃, CeO₂ and Al₂O₃, or “other oxides”:
between 0.5% and 12%;
the contents of Y₂O₃ and CeO₂, as molar percentages on the basis of the sum of ZrO₂, HfO₂, Y₂O₃ and CeO₂, being such that
1.8%≤Y₂O₃≤3% and
0.1%≤CeO₂≤0.9%,
the particle mixture including between 0.5% and 10% of particles of an oxide pigment, as a mass percentage on the basis of the particle mixture,
the content of oxides which are “other oxides” and which are not included in the oxide pigment being less than 2%, as a mass percentage on the basis of the oxides,
the particles of the oxide pigment consisting, for more than 95% of their mass, of a material chosen from:
oxide(s) of perovskite structure, optionally replaced, totally or partially, with an equivalent amount of precursor(s) of these oxides,
oxides of spinel structure, optionally replaced, totally or partially, with an equivalent amount of precursor(s) of these oxides,
oxides of hematite structure E₂O₃, the element E being chosen from the group G_{E}(1) formed by iron, chromium and mixtures of iron and chromium,
oxides of rutile structure FO₂, the element F being chosen from the group G_{F}(1) formed by mixtures of tin and vanadium, mixtures of titanium and chromium and niobium, mixtures of titanium and chromium and tungsten, mixtures of titanium and niobium and manganese, mixtures of tin and chromium, mixtures of chromium and titanium and antimony, mixtures of nickel and antimony and titanium, and mixtures thereof,
and mixtures thereof.

2. The particle mixture as claimed in claim 1, consisting of oxides for more than 99% of its mass, and/or in which more than 95% of the zirconium and/or hafnium and/or cerium and/or yttrium and/or aluminum is present in the form of zirconia, hafnia, ceria, a zirconia at least partially stabilized with Y₂O₃ and/or in the form of yttria and alumina, respectively.

3. The particle mixture as claimed in claim 1, in which:
the Y₂O₃ content is greater than or equal to 1.9% and less than or equal to 2.5%, as molar percentages on the basis of the sum of ZrO₂, HfO₂, Y₂O₃ and CeO₂; and/or
the CeO₂ content is greater than or equal to 0.3% and less than 0.7%, as molar percentages on the basis of the sum of ZrO₂, HfO₂, Y₂O₃ and CeO₂; and/or
the oxide pigment content is greater than 2% and less than 8%, as mass percentages on the basis of the oxides.

4. The particle mixture as claimed in claim 1, in which the Al₂O₃ content, as mass percentages on the basis of the oxides, is greater than or equal to 0.2% and less than or equal to 1.2%, or less than 0.1%.

5. The particle mixture as claimed in claim 1, in which the oxide pigment does not include the element cerium and/or does not include the element yttrium and/or does not include the element zirconium.

6. The particle mixture as claimed in claim 1, in which the oxide pigment consists for more than 95% of its mass of an oxide of spinel structure chosen from an iron-chromium spinel, an iron-cobalt spinel, an iron-chromium-cobalt spinel, a cobalt-magnesium-zinc-chromium spinel, a cobalt-nickel-iron-chromium spinel, a nickel-manganese iron-chromium spinel, a zinc-manganese-chromium-iron spinel, a manganese-iron spinel, a chromium-iron-nickel spinel, a cobalt-chromium spinel, a copper-chromium spinel, a cobalt-titanium spinel, an iron-titanium spinel, a zinc-iron spinel, a zinc-iron-chromium spinel, a cobalt-tin spinel, a nickel-iron spinel, an iron-manganese-chromium spinel, a zinc-manganese-chromium spinel and mixtures thereof.

7. The particle mixture as claimed in claim 6, in which the oxide pigment consists for more than 95% of its mass of an oxide of spinel structure chosen from an iron-chromium spinel having a mass ratio of iron expressed as Fe₂O₃ to chromium expressed as Cr₂O₃, Fe₂O₃/Cr₂O₃ of greater than 0 and less than 3, an iron-cobalt spinel having a mass ratio of iron expressed as Fe₂O₃ to cobalt expressed as Co₃O₄, Fe₂O₃/Co₃O₄ of greater than 0.5 and less than 4, an iron-chromium-cobalt spinel having a mass ratio of iron expressed as Fe₂O₃ to chromium expressed as Cr₂O₃, Fe₂O₃/Cr₂O₃ of greater than 0.5 and less than 3, and a mass ratio of iron expressed as Fe₂O₃ to cobalt expressed as Co₃O₄, Fe₂O₃/Co₃O₄ of greater than 0.5 and less than 3, and mixtures thereof.

8. The particle mixture as claimed in claim 1, having a median size (D₅₀) of less than 2 μm and/or a ratio (D₉₀-D₁₀)/D₅₀, of less than 2,

9. An intermediate product consisting of particles bound by means of an organic binder, said particles forming together, after debinding of the intermediate product, a particle mixture as claimed in claim 1.

10. The intermediate product as claimed in claim 9, in the form of a paste or a powder of granules with a median size of greater than 1 mm and less than 8 mm or of a powder of granules with a median size of greater than 20 μm and less than 100 μm,

11. A process for manufacturing a sintered colored zirconia product, said process including the following steps:
a) preparing a starting feedstock including a particle mixture as claimed in claim 1, and optionally one or more organic constituents;
b) forming said starting feedstock so as to obtain a preform;
c) sintering said preform under oxidizing conditions at a temperature greater than or equal to 1300° C., so as to obtain a sintered colored zirconia product.

12. A sintered colored zirconia product having a chemical analysis such that, as mass percentages on the basis of the oxides:
ZrO₂+HfO₂+Y₂O₃+CeO₂: the remainder to 100%;
0%≤Al₂O₃≤1.5%;
oxides other than ZrO₂, HfO₂, Y₂O₃, CeO₂ and Al₂O₃, or “other oxides”: between 0.5% and 12%;
the contents of Y₂O₃ and CeO₂, as molar percentages on the basis of the sum of ZrO₂, HfO₂ Y₂O₃ and CeO₂, being such that 1.8% Y₂O₃≤3% and 0.1%≤CeO₂≤0.9%,
between 0.5% and 10% of the oxide phases being in an oxide pigment, as mass percentages on the basis of the oxides,
the content of oxides which are “other oxides” and which are not included in the oxide pigment being less than 2%, as a mass percentage on the basis of the oxides,
the oxide pigment consisting for more than 95% of its mass of a material chosen from:
oxide(s) of perovskite structure,
oxides of spinal structure,
oxides of hematite structure E₂O₃, the element E being chosen from the group G_{E}(1) formed by iron, chromium and a mixture of iron and chromium,
oxides of rutile structure FO₂, the element F being chosen from the group G_{F}(1) formed by mixtures of tin and vanadium, mixtures of titanium and chromium and niobium, mixtures of titanium and chromium and tungsten, mixtures of titanium and niobium and manganese, mixtures of tin and chromium, mixtures of chromium and titanium and antimony, mixtures of nickel and antimony and titanium, and mixtures thereof,
and mixtures thereof.

13. The sintered colored zirconia product as claimed in claim 12, in which:
the Y₂O₃ content is greater than or equal to 1.9% and less than or equal to 2.5%, as molar percentages on the basis of the sum of ZrO₂, HfO₂, Y₂O₃ and CeO₂, and/or
the CeO₂ content is greater than or equal to 0.3% and less than 0.7%, as molar percentages on the basis of the sum of ZrO₂, HfO₂, Y₂O₃ and CeO₂, and/or
the oxide pigment content is greater than 2% and less than 8%, as mass percentages on the basis of the oxides, and/or
the monoclinic zirconia fraction is less than 10%, and/or
more than 95% of the cerium and yttrium and zirconium, as a mass percentage, is outside the pigment, in the form of an at least partially stabilized zirconia, and/or
more than 95% of the aluminum, as a mass percentage, is outside the oxide pigment, in the form of alumina.

14. The sintered colored zirconia product as claimed in claim 12, consisting for more than 99% of its mass of oxides, and/or having an average grain size of less than 2 μm, and/or having a grain size distribution with a standard deviation of less than 0.15 μm.

15. The sintered colored zirconia product as claimed in claim 12,
having a chemical composition such that, as a mass percentage on the basis of the oxides:
0%≤Al₂O₃≤1.2%;
oxides which are “other oxides” and which are not included in the oxide pigment, preferably impurities: <1%,
the contents of Y₂O₃ and CeO₂, as molar percentages on the basis of the sum of ZrO₂, HfO₂, Y₂O₃ and CeO₂, being such that the content of Y₂O₃ is greater than or equal to 1.9% and less than or equal to 2.5%, and the CeO₂ content is greater than or equal to 0.3% and less than 0.7%, and
containing 3% to 7% of an oxide pigment consisting for more than 95% of its mass of an oxide of spinel structure chosen from an iron-chromium spinel having a mass ratio of iron expressed as Fe₂O₃ to chromium expressed as Cr₂O₃, Fe₂O₃/Cr₂O₃ of greater than 0 and less than 3, an iron-cobalt spinel having a mass ratio of iron expressed as Fe₂O₃ to cobalt expressed as Co₃O₄, Fe₂O₃/Co₃O₄ of greater than 0.5 and less than 4, an iron-chromium-cobalt spinel having a mass ratio of iron expressed as Fe₂O₃ to chromium expressed as Cr₂O₃, Fe₂O₃/Cr₂O₃ of greater than 0.5 and less than 3, and a mass ratio of iron expressed as Fe₂O₃ to cobalt expressed as Co₃O₄, Fe₂O₃/Co₃O₄ of greater than 0.5 and less than 3, and mixtures thereof;
having an average grain size of less than 1.5 μm, and a grain size distribution with a standard deviation of less than 0.15 μm.

16. A sintered colored zirconia product obtained or capable of being obtained by means of the manufacturing process as claimed in claim 11.

17. A device chosen from the group consisting of an item of jewelry, a watch, a bracelet, a necklace, a ring, a brooch, a tie pin, a handbag, a telephone, an item of furniture, a household utensil, a handle, a switch, a button, a plating, a visible part of a consumer goods equipment, a spectacle frame part, a tableware item, a welding pin and a frame, said device including a sintered product as claimed in claim 12.
